(19) United States
(12) Patent Application Publication
(10) Pub. No.: US 2021/0299827 A1
(43) Pub. Date: Sep. 30, 2021

(54) OPTIMIZATION METHOD AND SYSTEM BASED ON SCREWDRIVING TECHNOLOGY IN MOBILE PHONE MANUFACTURING

(71) Applicant: GUANGDONG UNIVERSITY OF TECHNOLOGY, GUANGZHOU (CN)

(72) Inventors: Qiang LIU, GUANGZHOU (CN); Jiewu LENG, GUANGZHOU (CN); Qianyi SU, GUANGZHOU (CN); Ding ZHANG, GUANGZHOU (CN); Ailin YU, GUANGZHOU (CN)

(21) Appl. No.: 17/072,668

(22) Filed: Oct. 16, 2020

(30) Foreign Application Priority Data
Mar. 31, 2020 (CN) 202010246082.3

(51) Int. Cl. B25B 21/00

(52) U.S. Cl. CPC B25B 21/002

(57) ABSTRACT

Disclosed are an optimization method and a system based on a screwdriving technology in mobile phone manufacturing. The method comprises: acquiring mobile phone machining data; establishing a technological framework; determining initial screwdriving technological parameters and a range of the screwdriving technological parameters by a neural network algorithm; building a digital twin model of a screwdriving device by a digital twin technology and establishing a virtual-real synchronous real-object simulation platform to make a real object and a simulation model run synchronously; integrating the digital twin model of the screwdriving device with each module to synchronize data of the screwdriving device with data of each module; and if screwdriving feedback information is abnormal, optimizing the screwdriving technology according to the range of the parameters. A real-time running state can be tested and technological parameters can be monitored during technological process, and parameters in the screwdriving technological process can be adjusted in time.

### CROSS-REFERENCE TO RELATED APPLICATIONS

This application claims priority to Chinese Patent Application No. 202010246082.3 with a filing date of Mar. 31, 2020. The content of the aforementioned applications, including any intervening amendments thereto, are incorporated herein by reference.

### TECHNICAL FIELD

The disclosure relates to the field of screwdriving technologies, and more particularly, to an optimization method and a system based on a screwdriving technology in mobile phone manufacturing.

### BACKGROUND

Present knowledge about a screwdriving technology and a technological optimization field are mostly concentrated in high-speed rail or spacecraft fields, all of which requires a high accuracy, and mostly considers optimization of the screwdriving technology from aspects of a number of screwing turns, a screwing angle, a screw type selected, and the like according to experience accumulated by people at ordinary times. Meanwhile, screw parts used in mobile phone manufacturing are relatively small. In the past production lines for mobile phone manufacturing, such as mobile phone mainboard production, mobile phone assembly and the like, most screwdriving technologies were mainly manually operated to ensure machining. Therefore, in an existing mobile phone manufacturing industry, an auto-screwdriving operation realized by a screwdriving device is still in a development stage, lacking a complete knowledge system of the screwdriving technology oriented to mobile phone manufacturing, which is not conducive to intelligent optimization of the screwdriving technology. In an operation process of an existing auto-screwdriving device, most scholars only start from a mechanical structure of an auto-screwdriving machine, and adjust and innovate a design structure of the auto-screwdriving machine to optimize the operation of the auto-screwdriving machine, without thinking about various problems affecting a screwdriving quality in an actual screwdriving technological process. Therefore, there is a lack of a mapping relationship between the technology and the device.

### SUMMARY

The disclosure aims to propose an optimization method based on a screwdriving technology in mobile phone manufacturing, and according to the method, virtual-real synchronous running of the screwdriving technology is performed by establishing a digital twin model of a screwdriving device.

The disclosure further proposes an optimization system based on a screwdriving technology in mobile phone manufacturing, which comprises a mobile phone data acquisition module, a technological framework module, an algorithm module, an entity model module, a simulation platform and an information feedback module.

In order to achieve the objectives, the technical solutions used in the disclosure are as follows.

An optimization method based on a screwdriving technology in mobile phone manufacturing comprises the following steps of:

(1) taking a mobile phone as a machining object, and acquiring historical screwdriving technological parameter information of the mobile phone as well as device information and manufacturing data of a screwdriving device;

(2) establishing a screwdriving technological framework oriented to mobile phone manufacturing, the screwdriving technological framework comprising: technological parameter information, technological evaluation index information, operating tool information, screw locking information and safety stress range information;

(3) based on the screwdriving technological framework, analyzing historical screwdriving data by a neural network algorithm, and separating the data into different classification problems after abstract processing; using assembly demand data and device machining parameters as data sets to train a neural network model; and inputting manufacturing data required by an enterprise into the neural network model, and determining initial screwdriving technological parameters and a range of the screwdriving technological parameters;

(4) establishing a three-dimensional entity model of an auto-screwdriving machine; importing the three-dimensional entity model into a simulation platform, taking the initial screwdriving technological parameters in the step (3) as setting parameters for simulation operation of a simulation model of the screwdriving device to compile a screwdriving movement and an action control script, and performing, by the screwdriving device, simulation operation of a machining technology; and building a digital twin model of the screwdriving device by a digital twin technology, and establishing a virtual-real synchronous real-object simulation platform to make a real object and a simulation model of the screwdriving device run synchronously;

(5) integrating the digital twin model of the screwdriving device with each module relevant to the screwdriving technology to synchronize data of the screwdriving device with data of each module;

(6) acquiring feedback information of the digital twin model of the screwdriving device in real time, comprising: state information, technological parameters and test information of the screwdriving device; and if screwdriving feedback information is abnormal, adjusting, by the simulation platform, technological parameter values by a certain step size according to the range of the screwdriving technological parameters in the step (3) to optimize the screwdriving technology.

According to further description, the step (4) specifically comprises: establishing the three-dimensional entity model of the screwdriving machine, light-weighting the three-dimensional entity model, ignoring a structure irrelevant to the screwdriving technology, and importing the light-weighted three-dimensional entity model of the screwdriving machine into simulation software.

According to further description, the step (5) specifically comprises: integrating a MES system with the digital twin model to realize data interaction between the MES system and the digital twin model; establishing a virtual control network by the digital twin technology, establishing an instruction channel and an information channel, and providing data interaction to synchronize the data of the screwdriving device with the data of each module.

According to further description, the step (1) specifically comprises: taking the mobile phone as the machining object, connecting a server of a manufacturing factory of the mobile phone online, and acquiring the historical screwdriving technological parameter information of the mobile phone as well as the device information and the manufacturing data of the screwdriving device from the server.

According to further description, the step (3) specifically comprises: using the assembly demand data and the device machining parameters as the data sets to train the neural network model; and classifying and labeling different screws, inputting the manufacturing data required by the enterprise into the model, and determining the initial screwdriving technological parameters and the range of the screwdriving technological parameters.

An optimization system based on a screwdriving technology in mobile phone manufacturing comprises: a mobile phone data acquisition module, a technological framework module, an algorithm module, an entity model module, a simulation module, an information feedback module and a MES system, wherein:
the mobile phone data acquisition module is configured to take a mobile phone as a machining object, and acquire historical screwdriving technological parameter information of the mobile phone as well as device information and manufacturing data of a screwdriving device;
the technological framework module is configured to establish a screwdriving technological framework oriented to mobile phone manufacturing;
the algorithm module is configured to, based on the screwdriving technological framework, analyze historical screwdriving data by a neural network algorithm, and separate the data into different classification problems after abstract processing; use assembly demand data and device machining parameters as data sets to train a neural network model; and input manufacturing data required by an enterprise into the neural network model, and determine initial screwdriving technological parameters and a range of the screwdriving technological parameters;
the entity model module is configured to establish a three-dimensional entity model of an auto-screwdriving machine; and import the three-dimensional entity model into a simulation platform of the simulation module;
the simulation module is configured to take the initial screwdriving technological parameters as setting parameters for simulation operation of a simulation model of the screwdriving device to compile a screwdriving movement and an action control script, and perform, by the screwdriving device, simulation operation of a machining technology; and build a digital twin model of the screwdriving device by a digital twin technology, and establish a virtual-real synchronous real-object simulation platform to make a real object and a simulation model of the screwdriving device run synchronously;
the simulation module is further configured to receive a manufacture instruction of the MES system, and optimize the screwdriving technology as required in the manufacture instruction;
the data interaction module is configured to integrate the digital twin model of the screwdriving device with each module of the screwdriving technology for data interaction; acquire feedback information of the digital twin model of the screwdriving device in real time, comprising: state information, technological parameters and test information of the screwdriving device; and if screwdriving feedback information is abnormal, feedback the abnormality to the MES system; and
the MES system is configured to adjust technological parameter values by a certain step size according to the range of the screwdriving technological parameters in the algorithm module, and send the adjusted technological parameter values to the simulation module.

According to further description, the data interaction module is configured to integrate the MES system with the digital twin model for data interaction between the MES system and the digital twin model; and establish a virtual control network by the digital twin technology, and establish an instruction channel and an information channel to synchronize the data of the screwdriving device and the data of each module.

According to further description, the data interaction module is provided with a control network module, a data monitoring module and an acquisition system module;
the control network module is configured to integrate the digital twin model of the screwdriving device and the data monitoring module with the acquisition system module for data interaction;
the acquisition system module is configured to acquire feedback information of the digital twin model of the screwdriving device in real time; and
the data monitoring module is configured to determine whether the feedback information of the acquisition system module is abnormal in real time, and if the screwdriving feedback information is abnormal, feedback the abnormality to the MES system.

The disclosure has the beneficial effects as follows.

From the aspect of the screwdriving technology, the disclosure proposes to establish the digital twin model of the screwdriving machine through a relationship between the technology and the device, and use the virtual-real synchronous technology to ensure that the simulation model of the screwdriving technology and the real object of the screwdriving technology run synchronously. The virtual-real synchronous running of the screwdriving technology is performed, and the real-time running state is tested and the technological parameters are monitored in the screwdriving technological process through the established digital twin model of the screwdriving device, and the parameters in the screwdriving technological process are adjusted in time according to running results, thus optimizing the screwdriving technology.

### BRIEF DESCRIPTION OF THE DRAWINGS

FIG. 1 is a structure diagram of a screwdriving technological framework oriented to mobile phone manufacturing.

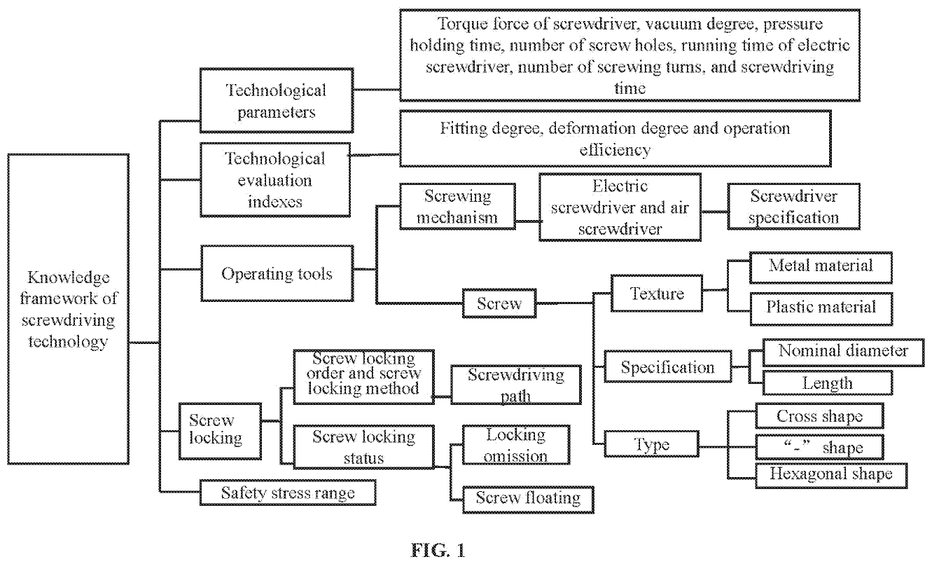

### DETAILED DESCRIPTION

The technical solutions of the disclosure are further described hereinafter with reference to the accompanying drawings and the specific embodiments.

The disclosure is based on the following premises.

(1) A design platform capable of performing three-dimensional digitalization and a corresponding three-dimensional visualization engine are provided, virtual equipment of a single device can be performed, and a motion of a device or a movement of a work-in-process may be controlled through a script, and a function of a soft PLC is possessed.

(2) An upper-layer MES system or an execution engine thereof are provided.

An optimization method based on a screwdriving technology in mobile phone manufacturing comprises the following steps.

(1) A mobile phone is taken as a machining object, and historical screwdriving technological parameter information of the mobile phone as well as device information and manufacturing data of a screwdriving device are acquired.

(2) A screwdriving technological framework oriented to mobile phone manufacturing is established, and the screwdriving technological framework comprises: technological parameter information, technological evaluation index information, operating tool information, screw locking information and safety stress range information.

The technological parameters comprise: a torque force of a screwdriver, a vacuum degree, a pressure holding time, a number of screw holes, a running time of an electric screwdriver, a number of screwing turns, and a screwdriving time.

The technological evaluation index information comprises: a fitting degree, a deformation degree and an operation efficiency.

The operating tool information comprises: a screwdriving mechanism type and a screw type, wherein the screwdriving mechanism type may be divided into an electric screwdriver type and an air screwdriver type. The screw may be made of a metal material and a plastic material, specifications of the screw may be classified according to a nominal diameter and a length, and the screw may be a cross shape, a “-” shape and a hexagonal shape.

The screw locking information comprises a screw locking order, a screw locking method and a screw locking status.

The safety stress range information is a stress magnitude after screw locking which implements best stability thereof.

(3) Based on the screwdriving technological framework, historical screwdriving technological data is analyzed by a neural network algorithm, and the data is separated into different classification problems after abstract processing. Assembly demand data and device machining parameters are used as data sets to train a neural network model. Manufacturing data required by an enterprise is inputted into the neural network model, and initial screwdriving technological parameters and a range of the screwdriving technological parameters are determined.

Characteristics of the historical data are extracted through the neural network algorithm, features and laws in these data are analyzed to achieve an effect of training the neural network model, and different classification problems are formed after abstract processing. The abstract processing is to strip useful information from an actual technology in reality, such as a movement of a workpiece and a component, a basic structure of the device, and the like, which is to split the data into different types of data (for example, some data belong to the assembly demand data (a hole size and a hole depth) and some data belong to the device machining parameters (such as a machining speed, a torque force, and the like). Moreover, useless information that does not have a great explanatory effect on the technological characteristics is discarded, such as routing arrangement of an electric wire and an air pipe, and the like. At the moment, when a new mobile phone needs to be assembled, only the assembly demand data of the new mobile phone needs to be inputted, and the manufacturing data required by the enterprise is inputted into the trained neural network model. The neural network predicts machining steps of the mobile phone and gives the initial screwdriving technological parameters, and may determine the range of the screwdriving technological parameter in combination with actual technological requirements and an actual machining capacity.

The assembly demand data refers to assembly features in the mobile phone, such as a screw hole size, a screw hole depth, a number of screw holes or a spacing between screw holes.

(4) A three-dimensional entity model of an auto-screwdriving machine is established; the three-dimensional entity model is imported into a simulation platform, the initial screwdriving technological parameters in the step (3) are taken as setting parameters for simulation operation of a simulation model of the screwdriving device to compile a screwdriving movement and an action control script, and simulation operation of a machining technology is performed by the screwdriving device. A digital twin model of the screwdriving device is built by a digital twin technology, and a virtual-real synchronous real-object simulation platform is established to make a real object and a simulation model of the screwdriving device run synchronously.

Three-dimensional modeling software commonly used in a computer terminal is selected for establishing the three-dimensional entity model. The screwdriving movement and the action control script are compiled as the control instructions, which may be programmed by a staff.

(5) The digital twin model of the screwdriving device is integrated with each module relevant to the screwdriving technology to synchronize data of the screwdriving device with data of each module.

(6) Feedback information of the digital twin model of the screwdriving device is acquired in real time, comprising: state information, technological parameters and test information of the screwdriving device. If screwdriving feedback information is abnormal, technological parameter values are adjusted by a certain step size according to the range of the screwdriving technological parameters in the step (3) by the simulation platform to optimize the screwdriving technology.

According to the initial screwdriving technological parameters and the range of the screwdriving technological parameters obtained in the step (3), an initial screwdriving speed is 2, with a speed range of 2 to 5. When the assembly is abnormal and an optimized step size is 0.5 (which may be set voluntarily), screwdriving is performed by the simulation platform at a speed of “2+0.5=2.5”, and the speed is constantly adjusted by the step size until the optimization is completed.

From the screwdriving technology, the disclosure proposes to establish the digital twin model of the screwdriving machine through a relationship between the technology and the device, and use the virtual-real synchronous technology to ensure that the simulation model of the screwdriving technology and the real object of the screw/driving device run synchronously. The virtual-real synchronous running of the screwdriving technology is performed, and the real-time running state is tested and the technological parameters are monitored in the screwdriving technological process through the established digital twin model of the screwdriving device, and the parameters in the screwdriving technological process are adjusted in time according to running results, thus optimizing the screwdriving technology.

According to further description, the step (4) specifically comprises: establishing the three-dimensional entity model of the screwdriving machine, light-weighting the three-dimensional entity model, ignoring a structure irrelevant to the screwdriving technology, and importing the light-weighted three-dimensional entity model of the screwdriving machine into simulation software.

Many small parts exist during three-dimensional modeling, such as Solidworks modeling, but these small parts are invisible, or irrelevant to a screwdriving movement of the screwdriving machine. A part irrelevant to the screwdriving technology is ignored, which can effectively reduce memory occupation, make drawing easier, and facilitate secondary development in the simulation software.

According to further description, the step (5) specifically comprises: integrating a MES system with the digital twin model to realize data interaction between the MES system and the digital twin model; establishing a virtual control network by the digital twin technology, establishing an instruction channel and an information channel, and providing data interaction to synchronize the data of the screwdriving device with the data of each module.

The MES system can generate a manufacture instruction and send the manufacture instruction to the simulation platform. The simulation software of the simulation platform drives the simulation model of the screwdriving device to move synchronously with the real object of the screwdriving device. The running state and the technological parameters are monitored and the screwdriving technology is tested through feedback of the digital twin model of the screwdriving device acquired by a data acquisition module and a monitoring module.

According to further description, the step (1) specifically comprises: taking the mobile phone as the machining object, connecting a server of a manufacturing factory of the mobile phone online, and acquiring the historical screwdriving technological parameter information of the mobile phone as well as the device information and the manufacturing data of the screwdriving device from the server.

The server of the manufacturing factory of the mobile phone is connected online to automatically acquire mobile phone machining data to be machined, without manual input and manual import. A customer may place an order online as needed for auto-machining and auto-production in the factory, thus being convenient and fast.

According to further description, the step (3) specifically comprises: using the assembly demand data and the device machining parameters as the data sets to train the neural network model; and classifying and labeling different screws, inputting the manufacturing data required by the enterprise into the model, and determining the initial screwdriving technological parameters and the range of the screwdriving technological parameters.

Labeling of the screw refers to unifying all parameters of the screw into a same label. For example, if a certain type of screw has a nominal diameter of a, a screw torque of b, and a coordinate of (x, y1-y2) to be installed, then the screw may be labeled as a first screw, and screws of the same specification may be called directly when inputting into the model, thus being simple, fast and convenient to classify.

An optimization system based on a screwdriving technology in mobile phone manufacturing comprises: a mobile phone data acquisition module, a technological framework module, an algorithm module, an entity model module, a simulation module, an information feedback module and a MES system.

The mobile phone data acquisition module is configured to take a mobile phone as a machining object, and acquire historical screwdriving technological parameter information of the mobile phone as well as device information and manufacturing data of a screwdriving device.

The technological framework module is configured to establish a screwdriving technological framework oriented to mobile phone manufacturing.

The screwdriving technological framework comprises: technological parameter information, technological evaluation index information, operating tool information, screw locking information and safety stress range information.

The algorithm module is configured to, based on the screwdriving technological framework, analyze historical screwdriving data by a neural network algorithm, and separate the data into different classification problems after abstract processing; use assembly demand data and device machining parameters as data sets to train a neural network model; and input manufacturing data required by an enterprise into the neural network model, and determine initial screwdriving technological parameters and a range of the screwdriving technological parameters.

The entity model module is configured to establish a three-dimensional entity model of an auto-screwdriving machine; and import the three-dimensional entity model into a simulation platform of the simulation module;

The simulation module is configured to take the initial screwdriving technological parameters as setting parameters for simulation operation of a simulation model of the screwdriving device to compile a screwdriving movement and an action control script, and perform, by the screwdriving device, simulation operation of a machining technology; and build a digital twin model of the screwdriving device by a digital twin technology, and establish a virtual-real synchronous real-object simulation platform to make a real object and a simulation model of the screwdriving device run synchronously.

The simulation module is further configured to receive a manufacture instruction of the MES system, and optimize the screwdriving technology as required in the manufacture instruction.

The data interaction module is configured to integrate the digital twin model of the screwdriving device with each module of the screwdriving technology for data interaction; acquire feedback information of the digital twin model of the screwdriving device in real time, comprising: state information, technological parameters and test information of the screwdriving device; and if screwdriving feedback information is abnormal, feedback the abnormality to the MES system.

The MES system is configured to adjust technological parameter values by a certain step size according to the range of the screwdriving technological parameters in the algorithm module, and send the adjusted technological parameter values to the simulation module.

According to further description, the data interaction module is configured to integrate the MES system with the digital twin model for data interaction between the MES system and the digital twin model; and establish a virtual control network by the digital twin technology, and establish an instruction channel and an information channel to synchronize the data of the screwdriving device and the data of each module.

According to further description, the data interaction module is provided with a control network module, a data monitoring module and an acquisition system module.

The control network module is configured to integrate the digital twin model of the screwdriving device and the data monitoring module with the acquisition system module for data interaction.

The acquisition system module is configured to acquire feedback information of the digital twin model of the screwdriving device in real time.

The data monitoring module is configured to determine whether the feedback information of the acquisition system module is abnormal in real time, and if the screwdriving feedback information is abnormal, feedback the abnormality to the MES system.

The technical principles of the disclosure are described above with reference to the specific embodiments. These descriptions are only for the purpose of explaining the principles of the disclosure, and cannot be explained as limiting the scope of protection of the disclosure in any way. Based on the explanation herein, those skilled in the art may think of other specific embodiments of the disclosure without going through any creative work, which will all fall within the scope of protection of the disclosure.

What is claimed is:

1. An optimization method based on a screwdriving technology in mobile phone manufacturing, comprising the following steps of:
(1) taking a mobile phone as a machining object, and acquiring historical screwdriving technological parameter information of the mobile phone as well as device information and manufacturing data of a screwdriving device;
(2) establishing a screwdriving technological framework oriented to mobile phone manufacturing, the screwdriving technological framework comprising: technological parameter information, technological evaluation index information, operating tool information, screw locking information and safety stress range information;
(3) based on the screwdriving technological framework, analyzing historical screwdriving data by a neural network algorithm, and separating the data into different classification problems after abstract processing; using assembly demand data and device machining parameters as data sets to train a neural network model; and inputting manufacturing data required by an enterprise into the neural network model, and determining initial screwdriving technological parameters and a range of the screwdriving technological parameters;
(4) establishing a three-dimensional entity model of an auto-screwdriving machine; importing the three-dimensional entity model into a simulation platform, taking the initial screwdriving technological parameters in the step (3) as setting parameters for simulation operation of a simulation model of the screwdriving device to compile a screwdriving movement and an action control script, and performing, by the screwdriving device, simulation operation of a machining technology; and building a digital twin model of the screwdriving device by a digital twin technology, and establishing a virtual-real synchronous real-object simulation platform to make a real object and a simulation model of the screwdriving device run synchronously;
(5) integrating the digital twin model of the screwdriving device with each module relevant to the screwdriving technology to synchronize data of the screwdriving device with data of each module;
(6) acquiring feedback information of the digital twin model of the screwdriving device in real time, comprising: state information, technological parameters and test information of the screwdriving device; and if screwdriving feedback information is abnormal, adjusting, by the simulation platform, technological parameter values by a certain step size according to the range of the screwdriving technological parameters in the step (3) to optimize the screwdriving technology.

2. The optimization method according to claim 1, wherein the step (4) specifically comprises: establishing the three-dimensional entity model of the screwdriving machine, light-weighting the three-dimensional entity model, ignoring a structure irrelevant to the screwdriving technology, and importing the light-weighted three-dimensional entity model of the screwdriving machine into simulation software.

3. The optimization method according to claim 1, wherein the step (5) specifically comprises: integrating a MES system with the digital twin model to realize data interaction between the MES system and the digital twin model; establishing a virtual control network by the digital twin technology, establishing an instruction channel and an information channel, and providing data interaction to synchronize the data of the screwdriving device with the data of each module.

4. The optimization method according to claim 1, wherein the step (1) specifically comprises: taking the mobile phone as the machining object, connecting a server of a manufacturing factory of the mobile phone online, and acquiring the historical screwdriving technological parameter information of the mobile phone as well as the device information and the manufacturing data of the screwdriving device from the server.

5. The optimization method according to claim 1, wherein the step (3) specifically comprises: using the assembly demand data and the device machining parameters as the data sets to train the neural network model; and classifying and labeling different screws, inputting the manufacturing data required by the enterprise into the model, and determining the initial screwdriving technological parameters and the range of the screwdriving technological parameters.

6. A system based on a screwdriving technology in mobile phone manufacturing, comprising: a mobile phone data acquisition module, a technological framework module, an algorithm module, an entity model module, an information feedback module and a MES system, wherein:
the mobile phone data acquisition module is configured to take a mobile phone as a machining object, and acquire historical screwdriving technological parameter information of the mobile phone as well as device information and manufacturing data of a screwdriving device;
the technological framework module is configured to establish a screwdriving technological framework oriented to mobile phone manufacturing;
the algorithm module is configured to, based on the screwdriving technological framework, analyze historical screwdriving data by a neural network algorithm, and separate the data into different classification problems after abstract processing; use assembly demand data and device machining parameters as data sets to train a neural network model; and input manufacturing data required by an enterprise into the neural network model, and determine initial screwdriving technological parameters and a range of the screwdriving technological parameters;
the entity model module is configured to establish a three-dimensional entity model of an auto-screwdriving machine; and import the three-dimensional entity model into a simulation platform of the simulation module;
the simulation module is configured to take the initial screwdriving technological parameters as setting parameters for simulation operation of a simulation model of the screwdriving device to compile a screwdriving movement and an action control script, and perform, by the screwdriving device, simulation operation of a machining technology; and build a digital twin model of the screwdriving device by a digital twin technology, and establish a virtual-real synchronous real-object simulation platform to make a real object and a simulation model of the screwdriving device run synchronously;
the simulation module is further configured to receive a manufacture instruction of the MES system, and optimize the screwdriving technology as required in the manufacture instruction;
the data interaction module is configured to integrate the digital twin model of the screwdriving device with each module of the screwdriving technology for data interaction; acquire feedback information of the digital twin model of the screwdriving device in real time, comprising: state information, technological parameters and test information of the screwdriving device; and if screwdriving feedback information is abnormal, feedback the abnormality to the MES system; and
the MES system is configured to adjust technological parameter values by a certain step size according to the range of the screwdriving technological parameters in the algorithm module, and send the adjusted technological parameter values to the simulation module.

7. The system based on the screwdriving technology in mobile phone manufacturing according to claim 6, wherein the data interaction module is configured to integrate the MES system with the digital twin model for data interaction between the MES system and the digital twin model; and establish a virtual control network by the digital twin technology, and establish an instruction channel and an information channel to synchronize the data of the screwdriving device and the data of each module.

8. The optimization system according to claim 7, wherein the data interaction module is provided with a control network module, a data monitoring module and an acquisition system module;
the control network module is configured to integrate the digital twin model of the screwdriving device and the data monitoring module with the acquisition system module for data interaction;
the acquisition system module is configured to acquire feedback information of the digital twin model of the screwdriving device in real time; and
the data monitoring module is configured to determine whether the feedback information of the acquisition system module is abnormal in real time, and if the screwdriving feedback information is abnormal, feedback the abnormality to the MES system.
